(19) United States
(12) Patent Application Publication
(10) Pub. No.: US 2011/0297582 A1
(43) Pub. Date: Dec. 8, 2011

(54) OIL REACTOR VACUUM PUMP HAVING HYDRAULIC GASKET FOR CATALYTIC OILING REACTIONS FROM PREVIOUSLY CONDITIONED SLURRY-LIKE RESIDUES AND METHOD THEREFOR

(76) Inventor: Christian Koch, Buttenheim (DE)

(21) Appl. No.: 13/202,344

(22) PCT Filed: Feb. 20, 2009
(86) PCT No.: PCT/DE2009/000246

§ 371 Date: Aug. 19, 2011

(30) Foreign Application Priority Data
Feb. 20, 2009 (DE) 102009012486.1

(51) Int. Cl. C10G 99/00; B01J 19/00

(52) U.S. Cl. 208/49; 422/187

(57) ABSTRACT

The invention describes a method and an apparatus for the diffusion-catalytic conversion of hydrocarbon-containing residues in two stages, in a first stage at 120-200° C., heated by the waste heat of the power generator in order to convert solid input materials into a reaction slurry and, in a second stage, to convert them into a middle distillate by way of a conversion using one or more oil reaction vacuum pumps, which are coated on the inside and equipped with a hydraulic gasket.

All petroleum and all oxygen of the atmosphere are the result of photosynthesis over more than one billion years of the Earth. They are the result of the disposal of the deceased organic material of the oceans and later the land by a diffusion-catalytic process at 14-17° C. mean temperature.

The question of how this process can be used for the current hydrocarbon-containing wastes in order to dispose of them in an environmentally friendly manner results in a diffusion-catalytic process without external heating, which is performed solely by the friction between the catalytic oil and the residue. This friction opens up the possibility of such a process, which consists of the following 5 steps: mixing, i.e., friction between catalyst and residues, adsorption, reaction, desorption, and removal or vaporization. Without friction, this process cannot get underway in a technically usable, rapid form.

The following invention shows how this process can be implemented in method and device in a technical implementation in a short time so it is long-lived, reliable, and therefore cost-effective. The method is concerned with the implementation of the reaction in an oil reactor vacuum pump having hydraulic gasket and the incorporation of this system in a production plant for middle distillates, which minimizes all conceivable risks and optimizes the production through a preprocessing technique. The device is concerned with the embodiment of this method using the available elements as a teaching of the implementation at an industrial scale. The respective exemplary embodiments explained the invention on the basis of an example.

Such a machine and plant are described in Patent DE 10 2005 056 735. The central element which allows the process is a high-performance chamber mixer in the patent. This allows the petroleum formation process to be repeated in approximately 3 minutes, the product uniformly being a middle distillate in accordance with the processing temperature.

The patent states in regard to this central element of the process that it follows the principle of the liquid ring vacuum pump and generates an overpressure of 1.5 bar on the overpressure side. This is significant progress over Patent 103 56 245 having its pumps and stirrers and very much higher pressures and problems in the pressure line, but still results in significant disadvantages in the application.

The liquid ring vacuum pump and the arrangement thereof, which is the central element and therefore the core of the plant in Patent DE 10 2005 056 735, further has an array of disadvantages which limit the reliability of the plant and therefore restrict the cost-effectiveness of the process.

Specifically, it has proven to be a disadvantage that the gasket systems of a liquid ring vacuum pump are fundamentally not adequate at the processing temperature of 250-320° C. and the introduction of the input material in the solid state can entrain so much air that the process does not continuously provide the expected results of the test operation, even in the high-performance chamber mixer.

The disadvantages are concentrated in the gasket system, which results in shutdown of the plant upon failure, and the introduction system, which results in a combustion reaction, in particular in the distillation area, upon formation of a windpipe in the introduction container due to the adhesion of the solids on the wall.

Surprisingly, it has now been found that hydraulics according to the invention offer the solution to the reliability problems of this technique. The hydraulics are built on the consideration that the elevated temperature of 250-320° C. does represent a high strain, which a vacuum pump cannot withstand continuously, but the medium of the conveyor unit changes from water to oil, and therefore the bearings and gaskets can be redesigned so that they are reliable in spite of the high temperature. This is also true for the input material, which must be subjected to a process in order to ensure the durable operation of the pump and the plant.

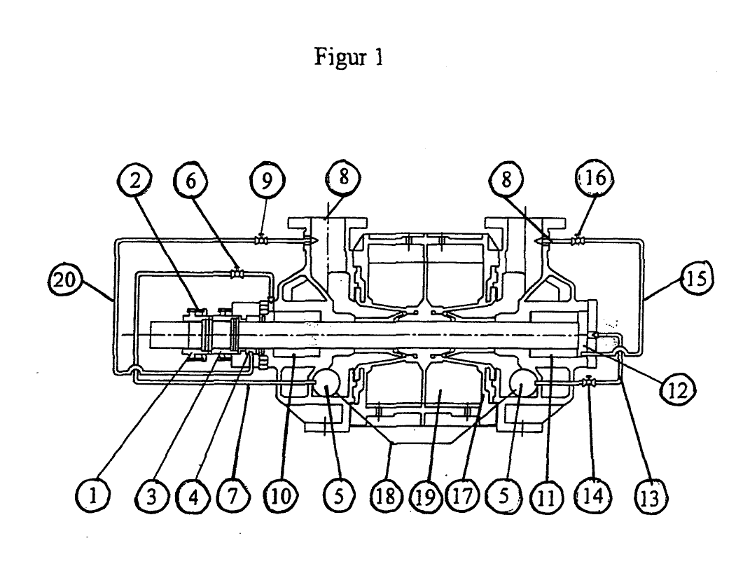

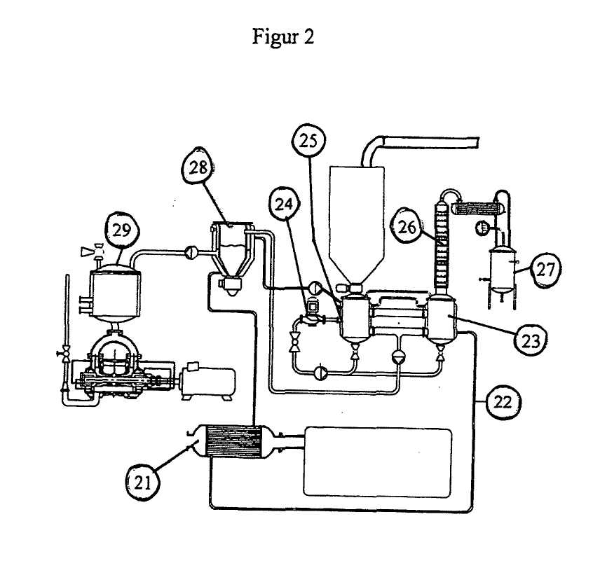

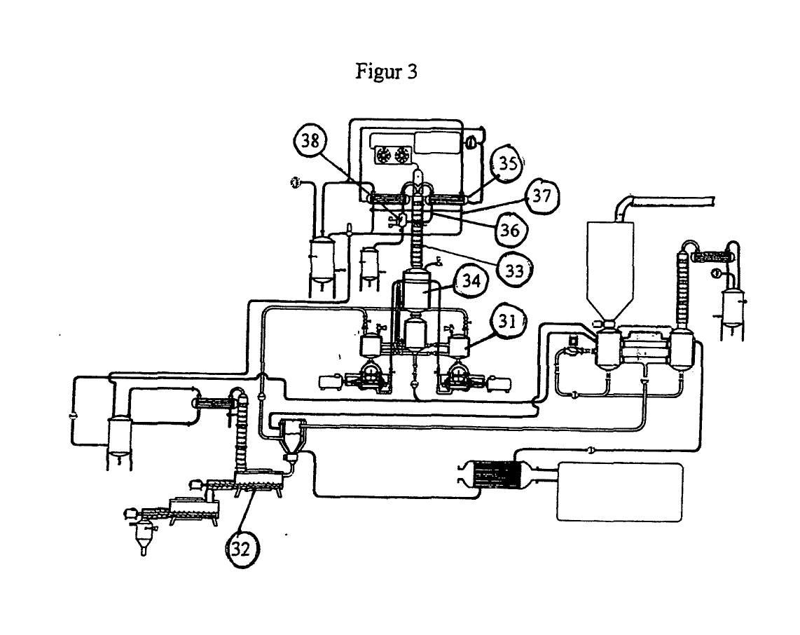

The hydraulics according to the invention comprise the gasket system being hydraulically controlled or regulated and the solid input materials being adapted to the conditions of the plant and the pump by a pre-process. FIG. 1 shows the oil reactor vacuum pump having hydraulic gasket according to the invention and FIG. 2 shows the incorporation according to the invention of the required pre-process for the operation of this oil reactor vacuum pump. FIG. 3 shows the entire process having the two components oil reactor vacuum pump and preprocessing technology.

Surprisingly, it has also been found that the diffusion-catalytic process only requires an addition of catalyst in the case of larger components of industrial hydrocarbons, such as plastics, rubbers, and oils. For input materials of predominantly biological origin, such as the residues from agriculture, the catalytic effects of the organic components of these materials are sufficient for the process. The inorganic components of the biological residues fundamentally contain the same structure as the catalysts, namely the aluminum silicates each having one of the metals of the first or second main group.

The description of FIG. 1 relates to the method for the changes of the vacuum pump which are necessary to make a reliable, thermally stable, and oil-tight unit therefrom, which achieves a long lifetime, full functional capability, and easy repair capability. The elements show how the hydraulic gasket and the coating of the parts coming into contact with the hot reaction oil allow the technical implementation.

The outer packing unit of the gasket, which is implemented as a gland nut, is identified by 1. It is activated using the screws 2, in order to prevent possibly occurring oil on the shaft from escaping. When this gland nut has exhausted its seal action, the gland nut 3 located before it allows a further stage of the gasket.

The hydraulic gasket is situated to optimize the sealing action. It comprises the oil chamber 4, located between the gland nut and the bearings, which has a connection to the pressure line 5 via the line 6, which is provided with a stopcock. The chamber 4 is controlled with respect to pressure via the line 7, which is connected to the partial vacuum line 20 of the oil reaction vacuum pump 8, via the valve 9, so that only a slight overpressure results in the chamber 4.

Therefore, the particles collected in the lower chamber half 4 can be discharged via the valve 9 and are not pressed into the bearing. Furthermore, sufficient oil is introduced on one side to lubricate the bearings 10 and, on the other side, the overpressure acting against the gaskets is kept so small that the gaskets can easily fulfill their tasks. A partial vacuum acts from the inside on the bearing, which sucks in the oil for lubrication.

According to a similar system, the lubrication of the bearing 11 operates on the encapsulated opposing side. The encapsulation forms a chamber 12 on the other side, which has a supply line 13 having the shutoff valve 14 from the pressure line of the oil reaction vacuum pump and has the discharge line for the particles 15 having the shutoff valve 16 in the lower part of the chamber. The lubrication capability of the content of the oil reaction vacuum pump is thus used for the bearing lubrication. This lubrication capability is provided in spite of the reaction temperature of 250° C.-320° C. in the oil reaction vacuum pump.

This results from the content materials introduced into the reaction in the oil reaction vacuum pump, such as cellulose, lignins, plastic, and rubber in the mixture. A component of a bitumen phase is thus also formed in the oil reaction vacuum pump, which guarantees sufficient lubrication even at the elevated temperatures in the case of sufficient quantity of through flow.

The oil reaction vacuum pump 17 has a coating, which is applied to the original parts of the casting, on all parts which come into contact with the medium. These are single-layer or multilayered coatings made of TiAlN or AlCrN, which are applied to the steel or GGG 50 casting.

Sufficient hardness and chemical protection against the reacting oils in the oil reaction vacuum pump thus results. The connection lines on the intake side of the oil reaction vacuum pump are identified by 8. On the pressure side, the oil reaction vacuum pump has the pressure line 18. The impeller 19, which is equipped with vanes, and which is either coated or manufactured from stainless steel, has a smaller diameter than the impeller of a vacuum pump. This does decrease the partial vacuum on the intake side, but also allows low-interference processing of solid components of the oil in the oiling process. The wall spacing of the impeller is increased from 0.5-1 mm to 3-10 mm.

FIG. 2 shows the incorporation of the oil reaction vacuum pump with the preprocessing technique. The oil reaction vacuum pump has a mechanical drive in the form of an electric motor, diesel engine, or gas turbine. In all 3 cases, waste heat is generated, which is used in a thermal oil loop for the preprocessing technique. The thermal oil, which is heated in the exhaust gas heat exchanger 21, reaches the jacket heaters of the preprocessing containers 23 and 25 and separator 28 via the thermal oil lines 22. An input flap or a shredder is situated at the input of the preprocessing container 25.

The material is thus heated in the preprocessing containers 23 and 25 and separator 28, it being kept in circulation by the mixer and pump unit 24. The supply of the condensate of the ash plant shown in FIG. 3 and catalyst-containing oils of the overall process then has the result that the water is replaced by these oils. The water vaporizes due to the supply of heat and is purified in the distillation unit 26, condensed, and collected in the water container 27. The slurry generated in the unit is supplied continuously as a function of the fill level of the plant via a conveyor unit and a separator 28 in the storage container 29 above the oil reaction vacuum pump.

FIG. 3 shows the integration of the oil reaction vacuum pump and the preprocessing technique in the overall oiling process and the oiling plant. The oil reaction vacuum pump having storage container is identified by 31. The ash plant is identified by 32, which supplies a partial stream from the separation container of a heating chamber having adjoining cooling chamber and ash container. This partial stream depends on the proportion of the nonreactive component of the input material of metal, ceramic, rocks, glass, and salt. The supply into the ash plant is 1.5 to 3 times this component, since oil and catalyst, which are reclaimed, can also be discharged with the partial stream.

The reclamation of the hydrocarbons is performed by the heating process to 400 to 500° C., the hydrocarbons being separated in the distillation and condensation and conducted back into the preprocessing technique of the figure. The catalyst is reclaimed by mixing with water, since it is suspended in the water and thus filtered off.

The distillation unit is identified by 33, which is located above the vaporizer 34. Vaporizer strips, which divide the oil stream coming from the oil reaction vacuum pump into a large number, 100 to 3000, of partial streams, are located in the vaporizer 34. A large vaporization surface for the resulting middle distillates thus results, which is discharged upward via the distillation unit 33 and therefore no longer reaches the storage container 31.

The condenser 35, in a single or double embodiment, liquefies the vapor. A small part is returned back to the column in the distillation column via the distillation return line 36, in order to regulate the upper head temperature of the column. This determines the type of the middle distillate as summer diesel, winter diesel, or kerosene. The line 37 conducts the product into the diesel tank, which has the connection line to one or more vacuum pumps, in order to thus ensure the security of the entire plant against escaping product.

The water separation tank 38 is situated on the input side of the condenser, in order to thus discharge the reaction water components into a tank. This quantity of water is exchanged with the product in the line until the upper level is reached in the water separation container 38.

When this is achieved, a conductivity sensor gives the signal to open the drain valve until the signal is no longer applied. The pH sensor, which determines the input quantity of neutralizing agent to the container 25 in FIG. 2, is attached in the lower part of this separation tank 38.

The ash plant is identified by 32, which is connected to the interior of the separator and which limits the concentration of the inorganic components of the plant. It receives sufficient material that the components still present at the input, such as glass, metal, and ceramic material, as well as the salts formed by the addition of lime, are limited in the overall plant. The ash plant has a heater which causes the included hydrocarbons to vaporize at 450-500° C. These are condensed and supplied to the preprocessing plant.

The oiling plant is identified by 33. It has up to 10 units of the oil reaction vacuum pumps around a container system 24, which causes the separation of the vaporized component and the liquid oil component. The vaporized components are purified by the distillation plant having return and condensation unit 35. The condensers have 2 output lines 36 and 37. They are connected in the interior of the condenser by an overflow to various chambers.

The line 36 also receives residual components of water from the first chamber, which exchange in the container 38 with the product therein through gravity. This container measures the pH value and periodically drains the excess water through a conductivity sensor and valve. The line 37 is the product line. It has a turbidity meter, which only permits the product which has adequate quality to the tank. The inadequate product is conducted into the condensate of the ash plant.

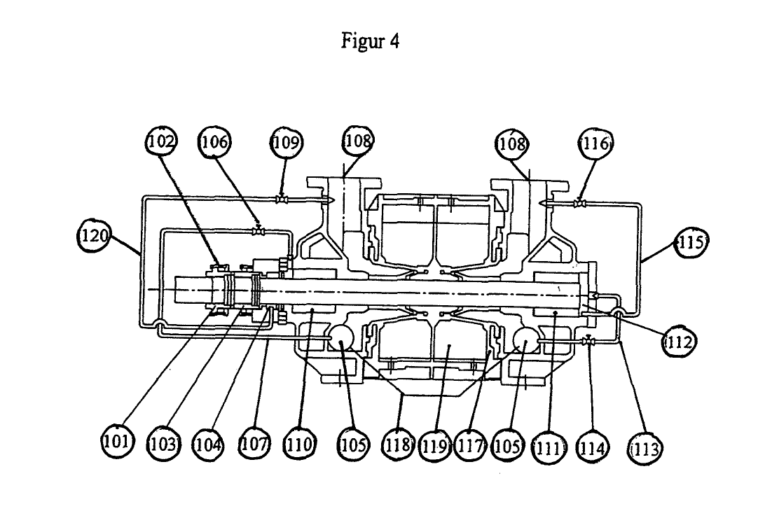

The description of FIG. 4 relates to the device for the changes of the vacuum pump which are necessary in order to make a reliable, thermally stable, and oil-tight unit therefrom, which achieves a long service life, full functional capability, and easy repair capability. The elements show how the hydraulic gasket and the coating of the parts which come into contact with the hot reaction oil allow the technical implementation.

The outer packing unit of the gasket, which is implemented as a gland nut, is identified by 101. It is formed by internal packing, a sleeve, and the screws. A second gland nut is additionally situated through the gland nut 103 lying before it.

A hydraulic gasket chamber 104 is situated on the shaft axis in the direction toward the oil reaction vacuum pump. It comprises the oil chamber 104 located between the gland nuts and the bearings, which has a connection to the pressure line 105 via the line 106, which is provided with a stopcock. The hydraulic gasket chamber 104 is connected with respect to pressure via the line 107, which is connected to the partial vacuum line 120 of the oil reaction vacuum pump 108, via the valve 109. The valve 109 has an electronic controller of the hydraulic gasket chamber 104.

The bearing 111 is located on the other side of the oil reaction vacuum pump. It forms the encapsulated opposing side. The encapsulation is implemented so that it has a chamber 112, which has a supply line 113 having the shutoff valve 114 from the pressure line of the oil reaction vacuum pump, and has the discharge line for the particles 115 having the shutoff valve 116 in the lower part of the chamber.

The oil reaction vacuum pump 117 has a coating, which is applied to the original parts of the casting, on all parts which come into contact with the medium. These are coatings made of TiAlN or AlCrN, single-layer or multilayered, which are applied to the steel or GGG 50 casting.

The connecting lines on the intake side of the oil reaction vacuum pump are identified by 118. On the pressure side, the oil reaction vacuum pump has the pressure line 118. The impeller 119, which is equipped with vanes, and which is either coated or manufactured from stainless steel, has a smaller diameter than the impeller of a vacuum pump. The wall spacing of the impeller is increased from 0.5-1 mm to 3-10 mm.

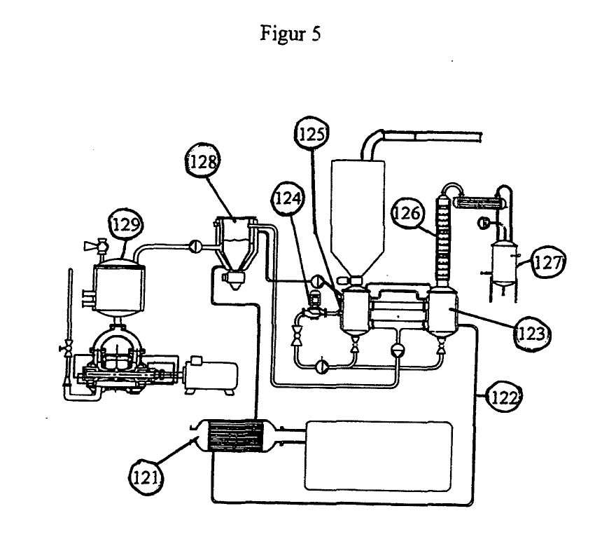

FIG. 5 shows the incorporation of the oil reaction vacuum pump in the preprocessing technique. The oil reaction vacuum pump has a mechanical drive in the form of an electric motor, diesel engine, or gas turbine. Thermal oil is provided in the exhaust gas heat exchanger 121. The exhaust gas heat exchanger 121 is connected via the thermal oil lines 122 to the jacket heaters of the preprocessing containers 123 and 125 and the separator 128. An input flap or a shredder is situated at the input of the preprocessing container 125.

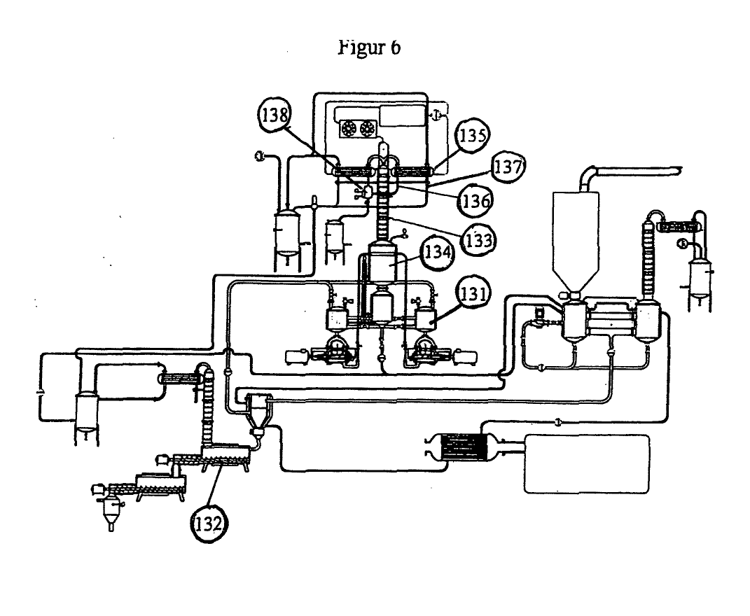

The preprocessing containers 123 and 125 and the separator 128 are connected to the mixer and pump unit 124 to form a circuit. A connection line to the preprocessing containers is installed with the ash plant shown in FIG. 6. The distillation unit 126, which is connected to water container 127, is situated on the preprocessing container 123. A connection line z to the storage container 129 is situated on the outlet of the separator 128.

FIG. 6 shows the arrangement in the oiling plant. The oil reaction vacuum pump having storage container is identified by 131. The ash plant, which has a connection line to the separator 138, is identified by 132. After the ash plant, a water mixing chamber is situated, having a catalyst screen as a catalyst reclamation plant.

The distillation unit, which is above the vaporizer 134, is identified by 133. Vaporizer strips having a large number, 100 to 3000, of exit holes are in the vaporizer 134. The distillation unit 133 is situated above, and an oil collection container is situated below, which has a connection line to the storage container 131.

The distillation column 133 is situated downstream from the condenser 135 in a single or double embodiment. This distillation column has the distillation return line 136 to the distillation column 133. The line 137 is connected to the diesel tank, which has the connection line to one or more vacuum pumps.

The water separation tank 138 is situated on the input side of the condenser. The pH sensor, which determines the input quantity of neutralizing agent at the container 125 in FIG. 2, is attached in the lower part of this separation tank 138.

The ash plant, which is connected to the interior of the separator, is identified by 132. The ash plant has a heater, which is designed for heating temperature of 600° C.

The oiling plant is identified by 131. It has up to 10 units of the oil reaction vacuum pumps around a container system 134. The distillation plant has a recirculation and condensation unit 135. The condensers have 2 output lines 136 and 137. They are connected in the interior of the condenser by an overflow to various chambers.

The line 136 is connected to the container 138, which contains conductivity meters and pH value meters. The line 137 is the product line. It has a turbidity sensor, which is connected using the two lines to the diesel tank and to the preprocessing plant.

The method according to the present invention is to be explained in greater detail in a special exemplary embodiment. For the oiling of 500 liters per hour of shredded tree trimming material, the oil reaction vacuum pump, which also represents the reactor for the conversion into middle distillates, has a shaft of 90 mm, a drive power using electric motor of 200 kW, and bearings having internal diameter of 90.8 mm an external diameter of 130 mm.

The pressure of the oil reaction vacuum pump on the pressure side is 1 bar and is 0.3 bar partial vacuum on the suction side. The hydraulic gasket chamber 4 is set by the relief valve 9 to a pressure of 0.05 bar overpressure. The pressure in the chamber 12 is set via the valve 14 so that overpressure prevails therein. This is set significantly higher than in the chamber 4 in accordance with the running noises of the oil reaction vacuum pump. The remaining dimensions are implemented according to the scale of FIG. 1.

The design of the exhaust gas heat exchanger of FIG. 2 is based on the gas stream of a 500 kW power generator. The thermal oil circuit 22 is kept at the temperatures of 360° C. in the flow and 240° C. in the return by the withdrawal of heat of the preprocessing technique. The containers 23, 25, and 28, which are heated using the thermal oil, have an external diameter of 1.4 m and a height of 1.4 m. The distillation column 26 has a diameter of 300 mm and a height of 2 m. The storage container before the oil reaction vacuum pump has a diameter of 1.5 m and a height of 1.5 m.

The ash plant shown in FIG. 3 has a hollow screw and a distillation plant having 200 mm diameter in both parts. The diameter of the heating screw is 400 mm and the diameter of the cooling screw is 300 mm. The actual oiling plant comprises the two oil reaction vacuum pumps and the circuit having the vaporizer 34, which has a diameter of 1.8 m. The distillation column located above it is a bubble tray column having a diameter of 600 mm and 3 m height. The condensers have a maximum output of 200 kW cooling power each using the cooling water 50/90° C.

The reaction water separator 38 having the conductivity sensor and the pH meter has the reflux line to the distillation column on top. The cooling water is kept at 50° C. by return cooling using the air heat exchanger. The device according to the invention is to be explained in greater detail in a further special exemplary embodiment. A plant for the production of 500 liters per hour middle distillate from shredded tree trimming material has the oil reaction vacuum pump, having a shaft of 90 mm, a drive power using electric motor of 200 kW, and bearings having internal diameter of 90.8 mm and external diameter of 130 mm.

The pressure of the oil reaction vacuum pump on the pressure side is 1 bar and is 0.3 bar partial vacuum on the suction side. The hydraulic gasket chamber 104 is set by the relief valve 109 to a pressure of 0.05 bar overpressure. The pressure in the chamber 112 is set via the valve 114 so that overpressure prevails therein. This is set significantly higher than in the chamber 104 in accordance with the running noises of the oil reaction vacuum pump. The remaining dimensions are implemented according to the scale of FIG. 4.

The design of the exhaust gas heat exchanger of FIG. 5 is based on the gas stream of a 500 kW power generator. The thermal oil circuit 22 is kept at the temperatures of 360° C. in the flow and 240° C. in the return by the withdrawal of heat of the preprocessing technique. The containers 123, 125, and 128 have connection lines between the exhaust gas heat exchanger and the container wall heater via a conveyor pump for hydraulic oil. These containers have an external diameter of 1.4 m and a height of 1.4 m. The distillation column 126 has a diameter of 300 mm and a height of 2 m. The storage container before the oil reaction vacuum pump has a diameter of 1.5 m and a height of 1.5 m.

The ash plant shown in FIG. 6 has a hollow screw and a distillation plant having 200 mm diameter in both parts. The diameter of the heating screw is 400 mm and the diameter of the cooling screw is 300 mm. The actual oiling plant comprises the two oil reaction vacuum pumps and the circuit having the vaporizer 134, which has a diameter of 1.8 m. The distillation column located above it is a bubble tray column having a diameter of 600 mm and 3 m height. The condensers have a maximum output of 200 kW cooling power each using the cooling water 50/90° C.

The reaction water separator 138 having the conductivity sensor and the pH meter has the reflux line to the distillation column on top. The cooling water is kept at 50° C. by return cooling using the air heat exchanger.

### LIST OF REFERENCE NUMERALS

### Reference Numerals for FIG. 1

1 outer packing unit of the gasket
2 screws
3 gland nut
4 oil chamber
5 connection to the pressure line
6 stopcock
7 line
8 suction line of the oil reaction vacuum pump
9 valve
10 bearing on the suction side
11 bearing
12 chamber on the pressure side
13 supply line
14 shutoff valve
15 discharge line
16 shutoff valve
17 oil reaction vacuum pump
18 pressure line
19 impeller
20 partial vacuum line

### Reference Numerals for FIG. 2

21 exhaust gas heat exchanger
22 thermal oil line
23 jacket heater of the preprocessing container
24 mixer and pump unit
25 preprocessing container
26 distillation unit
27 water container
28 separator
29 storage container

### Reference Numerals for FIG. 3

31 oil reaction vacuum pump having storage container
32 ash plant
33 distillation unit
34 vaporizer
35 condenser
36 distillation return line
37 product line
38 water separation container

### Reference Numerals for FIG. 4

101 the outer packing unit
102 screws of the packing
103 gland nut
104 hydraulic gasket chamber
105 pressure line
106 stopcock having line
107 line
108 oil reaction vacuum pump
109 valve
110 bearing on the shaft side
111 bearing on the encapsulated pressure side
112 chamber pressure side
113 supply line
114 shutoff valve
115 discharge line
116 shutoff valve
117 oil reaction vacuum pump
118 connecting line
119 impeller
120 partial vacuum line

### Reference Numerals for FIG. 5

121 exhaust gas heat exchanger
122 thermal oil line
123 preprocessing container
124 pump unit
125 preprocessing container
126 distillation unit
127 water container
128 separator
129 storage container

### Reference Numerals for FIG. 6

131 oil reaction vacuum pump having storage container
132 ash plant
133 distillation
134 vaporizer
135 condenser
136 distillation return line
137 product line
138 water separation tank

1. Method for the diffusion-catalytic conversion of hydrocarbon-containing residuals according to the model of petroleum formation of the Earth, the method comprising: intensive mixing with the catalyst, adsorption, reaction, desorption, and removal of the product in the form of vaporization, wherein the initiation of the products, the intensive mixing, is performed in 2 stages, the first stage of mixing the solid and liquid input materials, while heating using the waste heat of the power generator, with catalyst-containing oil from the main reaction in the temperature range below 200° C. in 30 to 200 minutes to form a slurry, and the second stage of converting this slurry in one or more oil reaction vacuum pumps at temperatures of 250-320° C. in minutes into a petroleum middle fraction.

2. Method according to claim 1, wherein the oil reaction vacuum pump has a hydraulic gasket on a drive side, which is located between the mechanical gaskets and the shaft bearing, through connection of this chamber to the output pressure line of the oil reaction vacuum pump in the upper area of this chamber and regulated connection of this chamber in the lower area of this chamber to the section line of the oil reaction vacuum pump in such a way that the bearing is sufficiently lubricated by the circulating oil and the overpressure of this chamber in the direction toward the seal is kept low.

3. Method according to claim 2, wherein a closed chamber is located on the side opposite to the drive, which, has a connection line to the pressure side of the oil reaction vacuum pump on the upper side of this chamber and has a settable or variable return line to the suction side of the oil reaction vacuum pump on the lower side, in order to discharge the particles located in the reaction oil from the chamber and regulate the bearing pressure.

4. Method according to claim 1, wherein the oil reaction vacuum pump has a wear-resistant, thermally stable, and hard surface coating made of TiAlN or AlCrN on all parts which touch the reaction mixture.

5. Device for diffusion-catalytic conversion of hydrocarbon-containing residuals, the device comprising at least 3 stages, having the first stage of the preprocessing technique having an intake container having airlock, pump, and mixer, a connection to a second container having outlet for the water vapor in the form of a distillation plant and for the pasty mass in the form of a separation container and apparatuses for the circuit in the form of pipeline, the second stage, connected to the lower part of the separation container via a valve airlock having a heated ash plant, and a third part, comprising the intake container, oil reaction vacuum pump and connection line, and container for the circuit and product discharge lines.

6. Device according to claim 5, wherein a hydraulic gasket is situated on the oil reaction vacuum pump on a drive side, which is located between the mechanical gaskets and the shaft bearing, has a connection line of this chamber to the output pressure line of the oil reaction vacuum pump in the upper area of this chamber and a suction line is situated in the lower area of this chamber, which has a pressure-regulated connection of this chamber of the oil reaction vacuum pump, which has an electrical connection to a pressure meter or has a manual adjustment unit.

7. Device according to claim 6, wherein a closed chamber is situated on the side opposite to the drive, which has a connection line to the pressure side of the oil reaction vacuum pump on the upper side of this chamber and has a settable or variable return line to the suction side of the oil reaction vacuum pump on the lower side, which is sufficiently large that the particles located in the reaction oil can drain out of the chamber.

8. Device according to claim 5, wherein the oil reaction vacuum pump has a wear-resistant, thermally stable, and hard surface coating made of TiAlN or AlCrN on all parts which contact the reaction mixture.
